(19) United States
(12) Patent Application Publication
(10) Pub. No.: US 2021/0331650 A1
(43) Pub. Date: Oct. 28, 2021

(54) DE-ICING SYSTEM FOR A SENSOR

(71) Applicant: Ibeo Automotive Systems GmbH, Hamburg (DE)

(72) Inventors: Domokos HALMOS, Friedrichshafen (DE); Simon FRICK, Wilhelmsdorf (DE); Daniel SLANGEN, Friedrichshafen (DE); Rainer KIESEL, Stetzingen (DE); Nicolas SCHREIBMÜLLER, Meckenbeuren (DE); Stefan HAKSPIEL, Tettnang (DE); Daniel PFEIFFER, Berg (DE); Tobias NUSSER, Friedrichshafen (DE); Heinz REICHERT, Markdorf (DE); Daniel SEGLER, Friedrichshafen (DE); Gerhard BIRKENMAIER, Tettnang (DE)

(21) Appl. No.: 17/343,877

(22) Filed: Jun. 10, 2021

Related U.S. Application Data
(63) Continuation of application No. PCT/EP2019/084068, filed on Dec. 6, 2019.

(30) Foreign Application Priority Data
Dec. 10, 2018 (DE) 102018221277.5

(51) Int. Cl. B60S 1/54

(52) U.S. Cl. CPC B60S 1/544

(57) ABSTRACT

A de-icing system for a sensor is provided. The de-icing system has a heating element for tempering a fluid, a flow generator for driving a fluid, and a cover element, which separates an external area from an internal area. The cover element is configured in such a way that a fluid driven by the flow generator flows along the cover element, in order to heat the cover element up.

### CROSS REFERENCE TO RELATED APPLICATIONS

This application is a continuation of International Application No. PCT/EP2019/084068, filed on Dec. 6, 2019, which claims priority from German Patent Application No. 10 2018 221 277.5, filed on Dec. 10, 2018, the contents of each of which are incorporated by reference herein.

### FIELD OF THE INVENTION

The invention relates to a de-icing system for a sensor.

### BACKGROUND

Various de-icing systems for sensors are known in the state of the art. For example a sensor is known, which transmits electromagnetic radiation through a cover element and again receives radiation reflected at an object through this cover element. Heating spirals are formed on the cover element, which enable the cover element to be heated up in order to defrost snow or ice. With sensors, which transmit and again receive electromagnetic radiation, such heating spirals which are formed from a metal and moreover lie in the sensor's field of view, can have a negative influence on the measurements performed.

### SUMMARY

The objective is to provide a de-icing system, which does not influence a measuring operation of a sensor.

The de-icing device is designed for de-icing a sensor. A sensor in terms of the patent specification may be a unit, which receives signals, but it may also be a system, which again receives a previously transmitted signal. In particular such a sensor is designed for ascertaining a distance, a spatial direction and/or a speed of an object within the field of view. The sensor comprises at least one detection element, which receives the signal and converts it into an electronic signal, which can be processed further. The sensor may also, as required, comprise a transmitting element, which transmits the signal to be received. Such a sensor may utilise acoustic, optical or even electromagnetic signals. Conveniently this is a RADAR or a LIDAR system, which as a transmitting and receiving system performs a distance and speed measurement of objects within a field of view.

The sensor and the de-icing system are intended for realisation in a motor vehicle. Such systems provide functions to the motor vehicle, which are needed for driver assistance systems or for autonomous driving.

The de-icing system includes among others a heating element for tempering a fluid. In addition the de-icing system comprises a flow generator, which drives the fluid. Further the de-icing system has a cover element formed on it, which separates an external area from an internal area, wherein the cover element is configured such that a fluid driven by the flow generator flows along the cover element and heats it up.

The heating element may be configured in various ways. A heating element, which for example is arranged on a main circuit board of a sensor, is particularly advantageous. This electrical heating element is for example shaped as a heating spiral. Conveniently the heating element is arranged outside the radiation path of a sensor. The heating element transfers the heating energy provided onto a fluid. This fluid may for example be a gas or a liquid. The use of air is particularly advantageous.

The flow generator, if using a liquid, is preferably realised by a pump, and if using a gas, is realised by a fan. The flow generator drives the fluid. This causes the fluid to flow past the heating element and absorb a portion of the generated heat energy. Subsequently the fluid flows along the cover element giving some of the absorbed thermal energy off to the same. This causes the cover element to heat up, so that a corresponding layer of snow or ice can detach itself from the cover element.

The cover element constitutes a separation between an external area and an internal area. Therefore the cover element comprises an outer side and an inner side. The external area is characterised in that this is directly exposed to external environmental influences. In other words the outer side presents a direct contact surface for environmental influences. The internal area is the area, which is not directly exposed to the external area, in particular this includes all those areas, which are arranged within the outer side. This also includes for example fluid channels, which are realised in the cover element.

The cover element is permeable to the signals of the sensor, in particular to its radiation. In case of electromagnetic radiation this includes at least that wavelength range, within which the sensor operates.

In particular the internal area is surrounded by a housing. This housing serves the sensor and/or the de-icing system. In particular the sensor is arranged within the housing. Advantageously the internal area is hermetically sealed against the external area and any environmental influences in an air-tight, water-tight, liquid-tight and/or splash-proof manner. Alternatively the housing may also provide a spatial separation, which comprises respective openings or fluid-permeable areas.

Due to such a de-icing system it is avoided that respective components of a de-icing system are arranged in a field of vision of the sensor/the transmitter or receiver. In particular, by choosing the correct fluid, in particular air, an influence on a measuring operation is negligible.

Advantageous embodiments of the de-icing system are now discussed below.

It is proposed that the fluid flows along an inner side of the cover element.

As a result the fluid is not disadvantageously affected by external influences. In particular if using air in the external area, external influences such as wind would be particularly disadvantageous. Since the internal space in most cases is better protected and also, as required, encapsulated, the flow path and also the transfer of heat can be significantly better protected. In addition due to heat input starting from an inner side of the cover element a snow or ice layer can start to melt. Once melting has started the snow or ice layer will drop off on its own or can be detached in other ways. In particular there is no need for the snow or ice to be thawed out completely.

Conveniently the fluid is guided along the cover element in such a way that the fluid is able to pass a maximum possible portion of absorbed heat onto the cover element. Such a guiding along can for example be provided by a flow channel.

With particular benefit the cover element comprises a flow channel for the fluid.

The fluid thus flows along inside the flow channel. Conveniently the flow channel extends right through the cover element. In particular the cover element is of double-wall or multi-wall construction. The cover element may be provided with a single flow channel or even a number of flow channels. Accordingly the cover element is of single-part or multi-part construction.

In particular the cover element provides a flow channel in that it is of double-wall construction. This allows an especially large flow cross-section to be achieved, as a result of which the fluid is able to heat the external surface of the cover element especially evenly.

The flow channel is thus arranged on the de-icing system within the outer side of the cover element and is therefore deemed to belong to the internal area.

The cover element may for example be manufactured from Plexiglas, Makrolon or glass.

Conveniently the heating element is arranged within the internal area or connected to the internal area via a feed line.

Due to the arrangement of the heating element within the internal area a compact, fully functional de-icing system is provided. This is complemented especially advantageously by correspondingly compact sensors. Such a system therefore includes all necessary components and can be assembled as a pre-fabricated module in a simple manner.

In another variant the heating element may also be arranged outside the internal area and may be connected via a feed line to the internal space. The internal area is in particular delimited by the housing. The tempered fluid is for example introduced via this feed line and guided to the cover element. Such a heating element may be any heating system existing in a motor vehicle such as for example an electrical heater, an external heater, also called auxiliary heater. The waste heat of a combustion engine may also be utilised for this purpose. In particular a heating system existing in a motor vehicle may be utilised, which in particular is used for an internal space.

Feeding-in conveniently takes place via fluid lines, which are connected to the housing or the cover element. A corresponding discharge line for discharging the fluid is also conveniently provided.

A combination of several heating elements is another possibility, wherein one element is preferably arranged in an internal space and the other is conveniently arranged outside of the internal space. An electrical heating element in the internal space may be employed for a first de-icing operation, for example prior to or at the beginning of a trip. As soon as the combustion engine provides the correct temperature, the heat provided in this way can prevent renewed icing-up. As a result there is no strain on the heating element as there would be through continuous operation.

Conveniently the flow generator is arranged inside the internal area or is connected to the internal space via a feed line.

This essentially corresponds to the statements in the 6 preceding paragraphs. In particular this enables a flow generator of the motor vehicle to be used, for example a ventilation system.

With particular benefit a heating element, conveniently any heating element, comprises a flow generator.

As a result an optimal flow of the fluid through the heating element occurs, which makes it possible to achieve an optimal heat transfer in favour of the cover element. A heating element outside of the internal space conveniently also comprises a flow generator. Equally a heating element inside of the internal space also comprises a flow generator.

A Nano coating is advantageously formed on the outer side of the cover element.

Due to the Nano coating it is possible for a respective ice layer to become detached more easily. In addition the Nano coating can provide advantageous characteristics for cleaning the cover element. In particular the Nano coating provides a kind of Lotus effect.

It is proposed that the de-icing system comprises a de-icing nozzle.

The de-icing nozzle can spray a cleaning or de-icing liquid onto the cover element, so that de-icing can take place quickly. In particular the de-icing nozzle may be constructed in a telescopic manner. When not needed, a telescopable cleaning nozzle can be retracted at least partially, preferably completely. Equally the same is extended, when a de-icing process takes place.

It is proposed that the de-icing system comprises a housing, which encloses an internal area or at least separates it from an external area.

The de-icing system will now be explained in detail by way of a FIGURE.

### BRIEF DESCRIPTION OF THE DRAWINGS

FIG. 1 displays a sensor and an associated de-icing system 12 which are schematically shown.

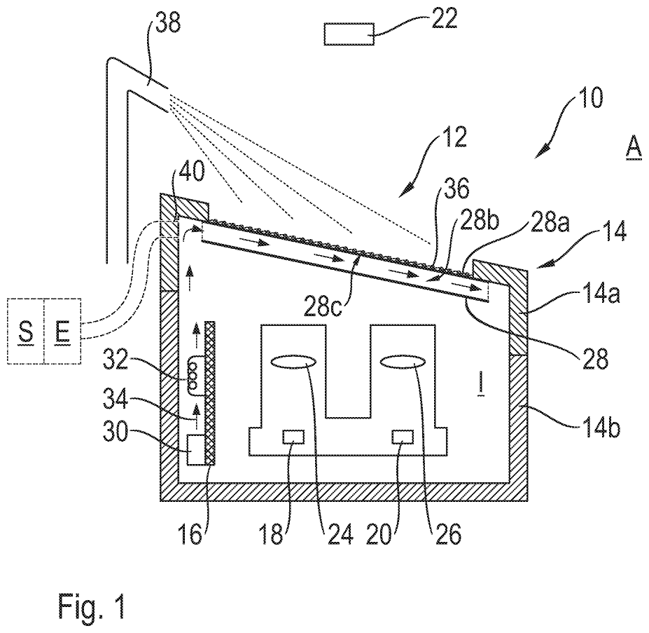

### DETAILED DESCRIPTION OF THE PREFERRED EMBODIMENTS

The sensor 10 and the de-icing system 12 are provided for realisation in a motor vehicle. The sensor 10 includes a housing 14, which at the same time also constitutes the housing of the de-icing system 12. The housing 14 is of multi-part construction for assembly and presented here by way of example as a housing part 14a and a housing part 14b.

The components of the sensor 10 are arranged completely within the housing 14, which hermetically seals the sensor 10 against an external area A. The sensor 10, which in this example is a LIDAR sensor, includes among others a circuit board 16, a transmitting chip 18 and a receiving chip 20 also called a detection element. The transmitting chip 18 emits electromagnetic waves in form of laser rays, which can be reflected in an object 22 within the field of vision. The reflected radiation can be detected by the detection element. The electromagnetic radiation passes among others through a transmitting optics 24 and a receiving optics 26 shown by way of example. The optics 24, 26 are shown merely as an example. In addition the electromagnetic radiation passes through a cover element 28, which is arranged on and attached to, the housing part 14a.

The cover element 28 is permeable to the electromagnetic radiation of the sensor 10. The LIDAR sensor is merely chosen as an example. The de-icing system 12 is in particular also suitable for a RADAR sensor, an imaging camera sensor or for sensors of another type. In particular the sensor is an optical sensor or a sensor which utilises electromagnetic radiation. The LIDAR sensor 10 ascertains a distance and a movement of the object 22.

The de-icing system 12 includes a cover element, a fan 30 which represents the flow generator, as well as a heating spiral 32, which represents the heating element. The cover element 28, which is also part of the de-icing system 12, separates an internal area I from an external area A. The external area is in direct contact with environmental influences. The internal area here is a hermetically sealed space, within which at least the individual components of the sensor are arranged. The cover element 28 therefore comprises an outer side 28a as well as an inner side 28c. In respective weather conditions a snow or ice layer may form on the outer side 28a of the cover sheet, which cannot be penetrated by the radiation of the sensor 10. Such a layer is defrosted by the de-icing system.

To this end the fan 30 drives the fluid along the depicted arrows 34. The fluid used here is air, wherein the use of liquids is also possible. Initially the fluid passes or flows through the heating wire 32 and is heated accordingly. Subsequently the fluid continues to flow further onto the cover element 28 and along the inner side of same along the cover element 28. The thermal energy previously absorbed by the heating element is thus passed onto the cover element 28, as a result of which the covering layer is detached or defrosted. In particular an initial thawing is of advantage, so that the ice layer can drop off as required.

The cover element 28 forms a flow channel 28b for the fluid, which is part of the internal space I. The fluid thus flows through the flow channel 28b, whereby the fluid is guided along the furthest distance along the cover element, in particular inside of the outer side 28a. The flow channel extends through the cover element 28/is formed by the cover element 28. The cover element 28 is made up of two parts, wherein the two discs, which are arranged and fastened at a distance from each other together with their in-between space, provide the flow channel. The discs of the cover element may for example be made from Makrolon, Plexiglas or glass.

The cover element 28 may also be constructed as a simple disc, wherein the fluid is directed onto the cover element. This, however, does not provide for a defined guidance of the fluid. The use of a flow channel by contrast permits a more efficient heat transfer along the entire surface of the cover element 28.

The heating element 32 is in this case realised as a heating wire 32. Alternatively the heating element may also be realised by a component of the main circuit board 16. The heating element may be formed on the main circuit board of sensor 10 or separately. The heating element 32 formed on the de-icing system and the flow generator 30 are both formed within the internal area.

In order to support the de-icing process the cover element 28 is optionally provided with a Nano coating 36. The Nano coating makes it easier for the ice layer to detach itself and thereby accelerates the de-icing process. In addition the Nano coating offers advantages during cleaning.

Furthermore provision may also be made for a de-icing nozzle 38. On demand the optional de-icing nozzle 38 sprays a de-icing liquid, which is distributed over the outer side of the cover element 28. The de-icing nozzle can also be used for a cleaning operation of a cleaning system.

In addition or as an alternative to the heating element 32 arranged in the internal space and the flow generator 30 provision may be made for a heating element E and a flow generator S. The flow generator S and the heater E are connected here via a feed line 40 for example to the internal space I. The feed line 40 is indicated merely by way of example. In addition a discharge line may be provided, which is not shown here. In particular the heating element E is a combustion engine or another heat source of a motor vehicle. The flow generator S may be realised as a separately formed fan or as a ventilation system of the motor vehicle. The flow generator S ensures that the fluid flows from the heating element E via the feed line 40 into the internal space and to the inner side 28c of the cover element 28.

Depending on how the de-icing system 12 is designed, various scenarios are possible for the operation of the heating elements 32 and E as well as for their associated flow generators, which however have already been discussed in the general description part. For example the heating element 32 may be switched off, as soon as the heating element E, for example said combustion engine, provides sufficient waste heat.

What is claimed is:

1. A de-icing system for a sensor, comprising
a heating element for tempering a fluid;
a flow generator for driving a fluid; and
a cover element, which separates an external area from an internal area, wherein the cover element is configured such that a fluid driven by the flow generator flows along the cover element, in order to heat the cover element.

2. The de-icing system according to claim 1, wherein the fluid flows along an inner side of the cover element.

3. The de-icing system according to claim 1, wherein the cover element comprises a flow channel for the fluid.

4. The de-icing system according to claim 1, wherein the heating element is arranged within the internal area or is connected via a feed line to the internal area.

5. The de-icing system according to claim 1, wherein the flow generator is arranged within the internal area or is connected via a feed line to the internal area.

6. The de-icing system according to claim 1, wherein a Nano coating is formed on the outer side of the cover element.

7. The de-icing system according to claim 1, wherein the de-icing system comprises a de-icing nozzle.
